(19) United States
(12) Patent Application Publication
(10) Pub. No.: US 2023/0292021 A1
(43) Pub. Date: Sep. 14, 2023

(54) OPTICAL METROLOGY: REPEATABLE QUALITATIVE ANALYSIS OF FLARE AND GHOST ARTIFACTS IN CAMERA OPTICAL SYTEM

(71) Applicant: Motional AD LLC, Boston, MA (US)

(72) Inventors: Nijumudheen MUHASSIN, Jefferson Hills, PA (US); Jayesh DWIVEDI, Oakmont, PA (US); Yew Kwang LOW, Singapore (SG)

(21) Appl. No.: 17/691,901

(22) Filed: Mar. 10, 2022

(51) Int. Cl. H04N 5/359; H04N 5/235

(52) U.S. Cl. CPC H04N 5/3597; H04N 5/2351; H04N 5/2354; B60R 1/22

(57) ABSTRACT

Provided are methods for optical metrologies in repeatable qualitative analyses of flare and ghost artifacts in camera optical systems, which can include receiving a first image of a light array captured by a camera, analyzing, using at least one data processor, the first image to detect a first light artifact, receiving a second image of the light array, captured by a camera, in which a first light source in the light array is turned off, and in response to determining that the first light artifact is absent from the second image, determining, using the at least one data processor and based on a position and/or an intensity of the first light source, a first adjustment for the camera. Systems and computer program products are also provided.

### BACKGROUND

An autonomous vehicle is capable of sensing its surrounding environment and navigating without human input. The vehicle may rely on various images and video captured by a camera or cameras for sensing and navigating. Captured images and video may include light artifacts that detrimentally impact the image and video quality. Modifying camera components may reduce or eliminate the presence of light artifacts in captured images and video.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIGS. 5A-5B are examples of a system for testing a camera optical system;

FIG. 6A-6C are examples of a testing environment for a camera optical system;

FIG. 7 is a flowchart for a process for a repeatable qualitative analysis of flare and ghost artifacts in a camera optical system;

FIG. 8 is a partial cross-sectional views of an example camera optical system; and

FIGS. 9A-9B are cross-sectional views of an example camera optical system.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement a repeatable qualitative analysis of flare and ghost artifacts in camera optical systems.

By virtue of the implementation of systems, methods, and computer program products described herein, techniques for an optical metrology for a repeatable qualitative analysis of flare and ghost artifacts in camera optical systems. Some advantages of the described techniques include improving image quality and accuracy of data received from captured images. For example, the reduction of light artifacts in captured images can allow for improved analysis of environments. This improved analysis can in turn be used for enhanced navigation and mapping of environments, especially in low-light environments.

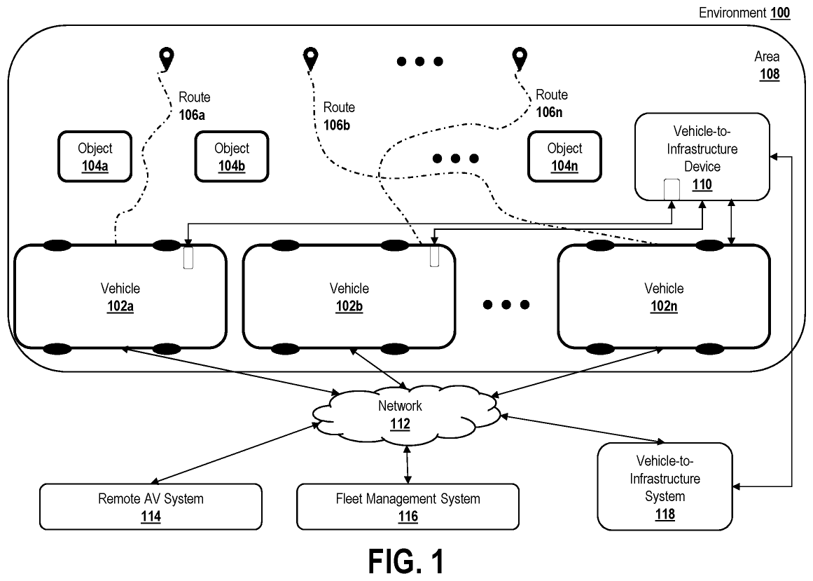

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

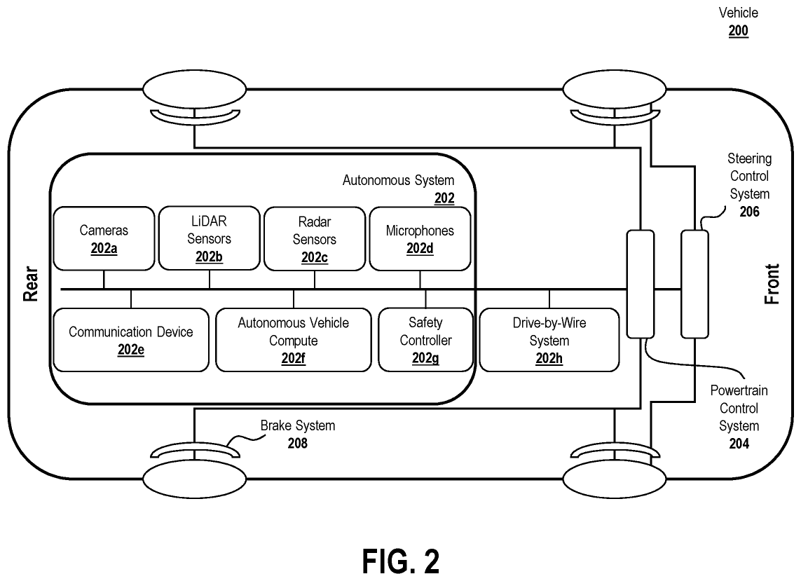

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

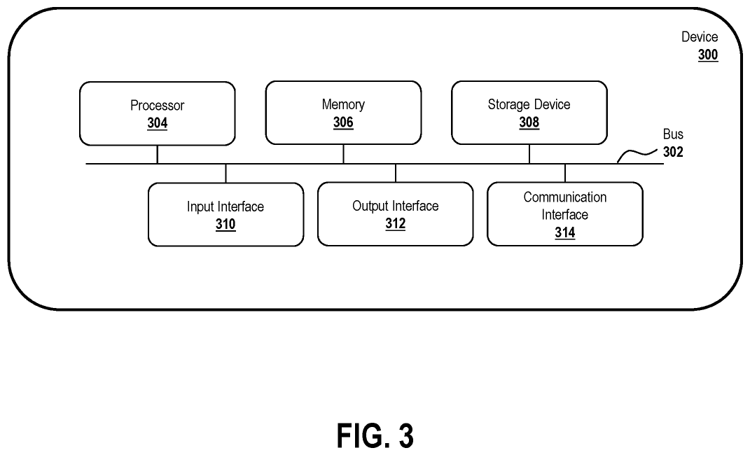

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

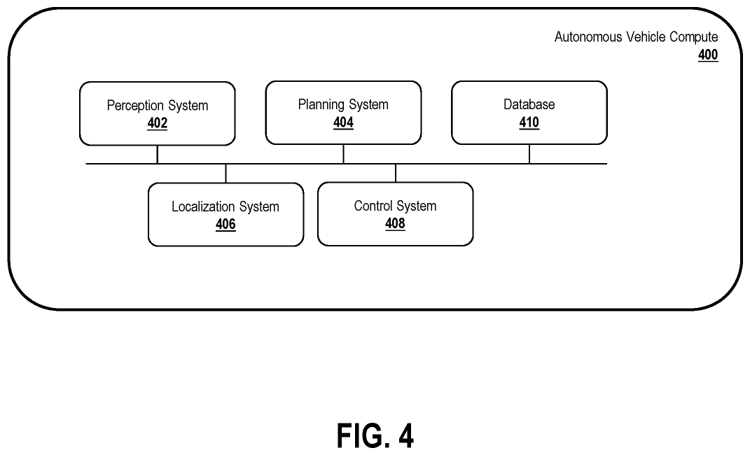

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIG. 4B.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

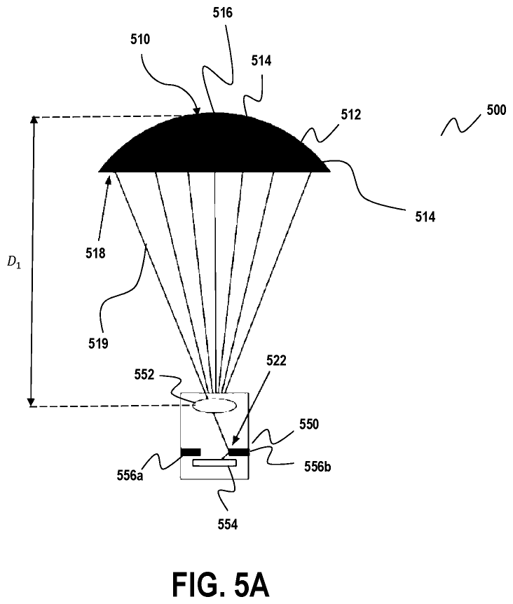

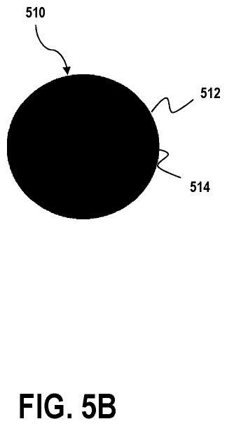

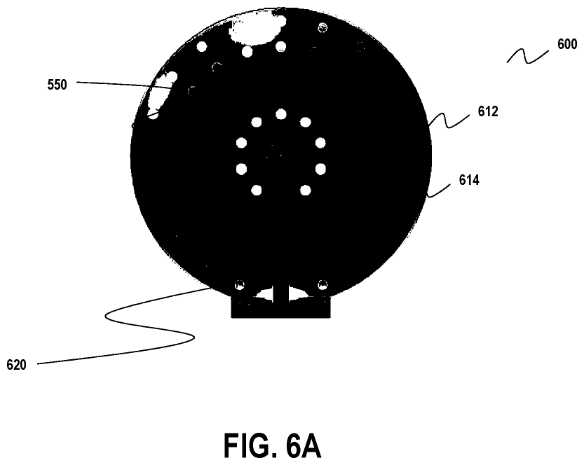

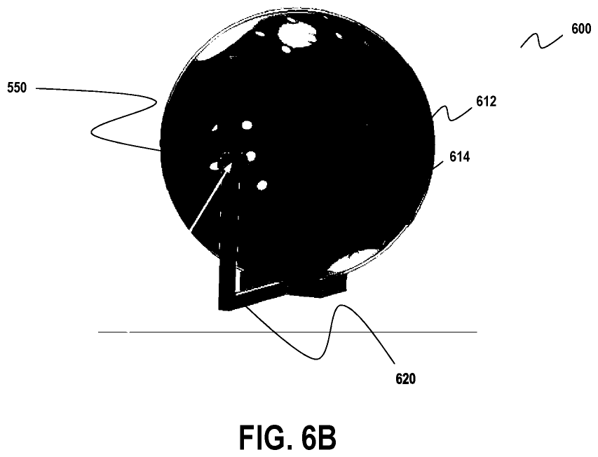

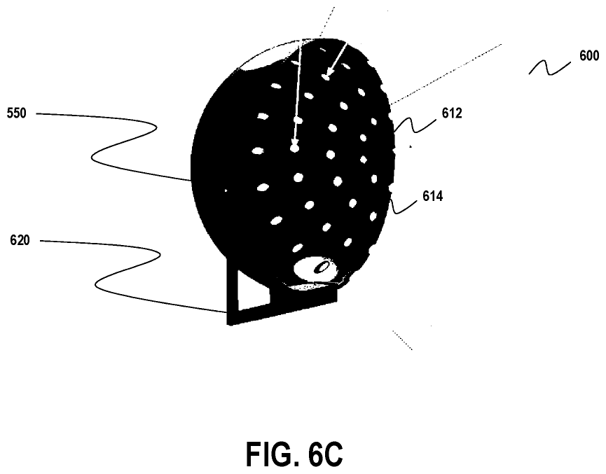

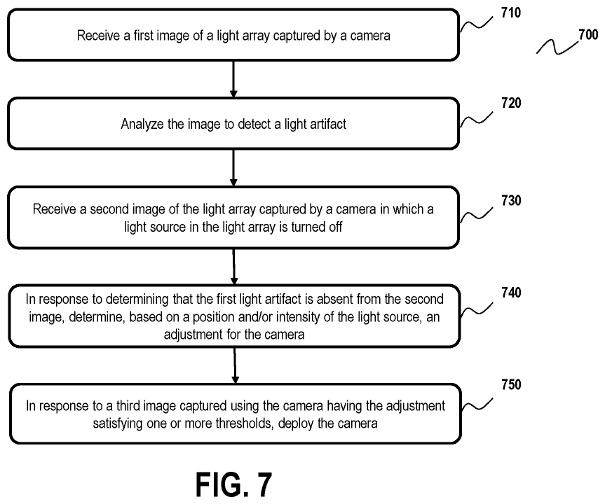

Referring now to FIGS. 5A-6C, illustrated are systems for reducing or eliminating the presence of light artifacts (e.g., flares, ghosting, glare, and/or effects of stray light) captured by a camera. FIGS. 5A and 5B illustrate an embodiment of a system 500 for reducing and/or eliminating light artifacts captured by a camera undergoing testing 550. FIGS. 6A-6C illustrate another embodiment of a system 600 for reducing and/or eliminating light artifacts captured by a camera undergoing testing 550. FIG. 7 is a flow chart illustrating an example of a process 700 for correcting light artifacts captured by a camera using the systems 500, 600 shown and described with respect to FIGS. 5A-6C.

A vehicle (e.g., an autonomous vehicle such as vehicles 102a-102n, vehicles 200, and the like) can include one or more cameras (e.g., cameras 202a, camera 550 and the like) that are used to assist in mapping and navigating environments. For example, the one or more cameras can capture images and/or video of an environment in which a vehicle is located, and the captured images and/or video are analyzed for the presence of objects or points of interest, such as obstacles, hazards, road conditions, and other information. Examples of obstacles include other vehicles, pedestrians, buildings, etc., while examples of road conditions include a location of travel lanes, turns, intersections, stoplights, road signs, and other information related to driving. In order to accurately map and navigate environments, the quality of the images and/or video captured must be sufficient so as to provide the sought information in an accurate manner. Certain factors can detrimentally affect the quality of the captured images and video, including the presence of light artifacts. Light artifacts are caused by scattered light entering a camera and contacting a sensor in the camera in an unintended matter. For example, light can bounce off internal and/or external camera components both before and after passing through a lens. This scattered light can show up in images captured by the camera and obscure, blur, or cloud the intended target of the image or video, resulting in sub-optimal or even ineffective image capture. Examples of light artifacts include flares, ghosting, and glares. In the context of vehicle cameras, the presence of light artifacts in the images can, in turn, lead to poor mapping and navigation by vehicles relying upon the captured images and the data they provide.

The effects of light artifacts can be made worse when driving in certain conditions including, for example, night driving and other low-light environments. As vehicle cameras increase their light sensitivity to maintain accuracy of data collection while navigating and mapping in these environments, light from streetlights, vehicles, and other sources can enter a vehicle camera and more easily disrupt the camera's ability to function at the required level. However, this disruption can potentially occur under a wide range of circumstances, including both low-level and high-level light environments, under varying weather conditions, and more. The systems and procedures described herein provide means for improving image quality for vehicle cameras through the reduction of light artifacts, and thus for improving mapping and navigation capabilities of vehicles when relying on these cameras, especially in difficult driving environments.

FIG. 5A illustrates a system 500 for reducing or eliminating the presence of light artifacts contained in an image captured by a camera 550. The system 500 depicted includes a light array 510 and a camera undergoing testing 550 placed a distance D₁ away from the light array 510. Camera 550 is focused on at least a portion of a light array 510. Light array 510 is a surface 512 upon which light sources 514 (e.g., LEDs) are placed. These light sources 514 are discussed in more detail below, as included in the discussion with respect to FIG. 5B. The surface 512 can be a variety of shapes such as, for example, a flat surface or a curved surface, and the surface shapes could be regular or irregular, depending upon the system requirements. In an embodiment, the surface 512 of the light array 510 is a hemispherical surface, and the light sources 514 are placed at regular intervals on the surface 512. In another embodiment, the light sources 514 are placed at irregular intervals on the surface 512, in order to, for example, emphasize certain spaces for testing inside or outside of the camera's 550 field of view.

The camera undergoing testing 550 in FIG. 5A is depicted with an exemplary internal structure, including a lens 552, a sensor 554, and a baffle 556a, 556b. This camera 550 is shown being placed a distance, D₁, away from a central light source 516 in the light array 510, and this distance is dependent upon the field of view and focus distance of the camera undergoing testing 550. For example, D₁ may be smaller for cameras with a wider field of view, and D₁ may be larger for cameras with a smaller field of view. Because light sources 514 outside of the field of view of a camera 550 can still contribute to light artifacts in images captured by a camera 550, a comprehensive testing system may require that the light sources 514 in the light array 510 span the whole field of view of the camera 550, with some other light sources 514 being disposed outside of the field of view. Therefore, D₁ will vary depending upon testing needs. In an alternative embodiment, for example in a limited testing system, the light sources 514 in the array 510 are placed at specific positions relative to the camera's 550 field of view to target certain components in the camera, or certain regions inside of or outside of the camera's 550 field of view. When the light array 510 is hemispherical, the camera 550 can be placed with a lens 552 substantially at the center of a sphere at least partially defined by the light array 510, such that D₁ is equal or approximately equal to the radius of the sphere.

During a testing process, light sources 514 in the array 510 are variously turned on or off as images are captured and analyzed for the presence of light artifacts. When the presence of a light artifact is determined to be at least partially attributable to a light source 514 in the light array 510, an appropriate modification can be made to the camera 550 so that subsequent images captured by the modified camera 550 will not contain a light artifact, even when the formerly responsible light source 514 is powered on. FIG. 5A depicts a responsible light source 518 emitting a ray of light 520 that may result in a light artifact. The ray 520 is shown entering a camera 550 through a lens 552, impacting a baffle 556b at 522, and contacting a sensor 554.

After a testing process, camera 550 is deployed for use in a vehicle.

Referring now to FIG. 5B, illustrated is an alternative view of a light array 510 depicted in FIG. 5A. From this view, light array 510 is circular in shape and has light sources 514 placed at regular intervals thereupon, although other shapes are contemplated herein, including, for example, rectangular, elliptical, or irregular shapes. In order to reduce or eliminate unwanted reflection off a surface 512 of the light array 514, the surface 512 is painted or coated in a darker material, for example, a matte black material or paint.

The light sources 514 shown in FIG. 5B are placed at a center point of the surface 512 and at three concentric rings upon the surface 512 at 45° steps, although the light sources 514 could be placed at any number of concentric rings and at less than 45° steps or greater than 45° steps. Alternatively, the light sources 514 could be arranged in a different pattern, for example, in a grid pattern or in an irregular pattern. In an embodiment, light sources 514 in a light array 510 are tunable LEDs with an adjustable intensity, although other light sources 514 could be used in place of, or in combination with, tunable LEDs. The illuminance of the LEDs could be independently controllable at an individual level and/or they could be controlled in sections or as a whole, as adjustments are needed during a testing process. In an embodiment, an illuminance of tunable LEDs ranges from 1 lux to 10,000 lux. Control of an illuminance of LEDs aids in simulating a variety of environments and could replicate near-darkness light levels, near-direct sunlight light levels, and any level in between.

In some embodiments, light sources 514 have an adjustable hue in place of, or in addition to, an adjustable illuminance. In an embodiment, light sources 514 are tunable LEDs that can be set to a specific light wavelength, i.e., red, green, or blue. Testing using varied wavelengths can be used to evaluate chromatic aberrations in a camera undergoing testing.

Referring now to FIGS. 6A-6C, illustrated is another embodiment of a system 600 like the kind depicted in FIGS. 5A and 5B. FIGS. 6A-6C depict a light array 610 in the form of a spherical surface 612. FIGS. 6A and 6B show a rear view and a partial side view of the system 600. FIG. 6C shows a partial sectional view of system 600 in which a spherical surface 612 is bisected to better highlight an interior of a spherical surface 612 and a camera 550 undergoing testing. The spherical surface 612 is shown with numerous light sources 614 arranged at regular intervals thereon. A light array 610 is shown seated upon a base with an arm extension 620, and a camera 550 undergoing testing 550 is shown atop the arm extension. While FIGS. 6A-6C depict a camera undergoing testing being placed at an outer edge of the spherical surface 612, a camera 550 can be placed at other locations relative to the light array 610, including, for example, in a center of a light array 610. Further, while a spherical surface 612 is shown having light sources 614 covering only a partial region of a surface 614, more or less of a surface 612 may include light sources 614. For example, an entire surface 612 may include light sources 614 arranged thereon.

Referring now to FIG. 7, illustrated is a process 700 for reducing or eliminating the presence of light artifacts in a camera 550 using the systems discussed above and shown in FIGS. 5A-6C.

At 710, a first image of a light array captured by a camera undergoing testing is received. A first image is receivable in any manner such as, for example, wireless and/or wired transmission. A light array captured in the first image has at least one light source powered on, and in an embodiment, all light sources in an array are powered on. In another embodiment, a cluster of light sources in a light array are turned on to localize an analysis on a particular angular space inside of or outside of a camera's field of view.

A first image is analyzed at 710 for the presence of a light artifact using at least one data processor. In the embodiment depicted, for example, in FIG. 5A, a position of the light sources in the light array can be represented using traditional spherical coordinates (r, θ, φ), where r is the distance from the lens to the light array, equal to D1, θ is the azimuthal angle, and φ is the polar angle. Using this notation, a light source or light sources can be tracked during an analysis process. In embodiments where light sources are disposed on a light array in a different manner, or where a light array is not a hemispherical surface, other means for recording position may be used as is deemed appropriate for a particular configuration and system being used.

In some embodiments, a first image may contain more than one light artifact. This can occur, for example, if more than one light source in a light array is powered on, and the more than one light sources contribute to the creation of separate light artifacts. Moreover, it is possible that one light source can contribute to the creation of more than one light artifact, if, for example, a light source creates a light ray which impacts a portion of a camera, and partial reflection and partial refraction occur to “split” the light ray into more than one light ray. The more than one light ray could lead to more than one light artifact if the more than one ray impacts the camera sensor more than once. It may even be possible for combinations of the aforementioned scenarios to take place simultaneously, such that several light sources are powered on, and more than one of those light sources contributes to the creation of more than one light artifact each. Where it is desirable to minimize the amount of light artifacts present in an initial image, lights may be toggled until an image is captured containing only one artifact.

In instances where more than one artifact is generated in a first image from one or more light sources, multiple camera modifications may be required to satisfy one or more thresholds required for deployment. Camera modifications are discussed in greater detail below.

Alternatively, in other embodiments, it may be possible that a first image contains no light artifacts at all, in which case operations 710 and 720 may be repeated with images of a array having at least one different configuration. For example, one or more light sources occupying different positions within a light array may be powered on (or off). Alternatively and/or additionally, an intensity of one or more light sources in a light array may be adjusted for the subsequent images.

If a first image contains at least one light artifact, a position and/or intensity of a light source or sources that are turned on in a captured image are noted. If, after a first image is analyzed at 720, no light artifacts are present, operations 710 and 720 can be repeated with a different configuration of a light source or light sources powered on. It should be appreciated that operations 710 and 720 may be repeated until an image is captured containing at least one light artifact. Once such an image is captured, the process can continue at 730.

In some embodiments, the order of turning on/off light sources in a light array prior to capturing images can be streamlined using information known about a camera, including, for example, a placement of components, or previous testing information. Additionally, information about the types of artifacts present, their locations, colors, shapes, etc. can be used to focus the process on a certain region of a camera's field of view using only a portion of the total light sources in a light array.

At 730, a second image captured by a camera undergoing testing is received. A second image can be received in the same manner as a first image, or in a different manner, such as, for example, through wired or wireless transmission as discussed previously. A second image captured by a camera has at least one light source, previously turned on for a first image, turned off. In another embodiment, a second image captured by a camera has at least one light source, previously turned on for a first image, set to a different illuminance than in a first image. In a further embodiment, the at least one light source, previously turned on for the first image, is set to a different wavelength than for a first image. In still another embodiment, a combination of power state, illuminance, and wavelength is altered. A second image is then analyzed for the presence of an at least one light artifact that was present in a first image. Analysis of a second image can be undertaken in the same manner as analysis of a first image or in a different manner.

If, after analysis of a second image, a light artifact contained in a first image is no longer present, then it can be concluded that a light source or light sources powered off prior to capturing a second image at least partially contributed to the creation of a light artifact. Once a contributing light source or light sources are identified, an adjustment for a camera under testing can be determined, based on an intensity and/or position of an identified light source or light sources, at 740.

In some embodiments, when identifying light sources on an array which at least partially contribute to the creation of light artifacts in images, the process 700 can employ one or more additional tilt, move, and/or rotation stages in which a position of a light array is altered prior to capturing images with a camera undergoing testing. For example, a tilt stage could encompass adjusting a relative angle between a camera undergoing testing and a light array prior to capturing a photo, where an adjustment results in a light array no longer being square to the camera lens. Additionally, a move stage could involve altering a distance from a camera to a light array, such that portions of a light array occupy more or less of a total field of view. Further, a rotation stage could involve rotating a light array and/or a camera relative to one another. These additional stages may allow for finer sampling of a camera's field of view to thoroughly source and account for as many potential light source position contributing to light artifacts as possible. These additional tilt, move, and/or rotation stages can be performed separately, or in combination with one another, and they may involve movement of a light array, a camera, or both.

As discussed previously, components of cameras themselves contribute to the creation of light artifacts. A component or components creating a light artifact contained in a first image can be located using a position and/or intensity information of an identified light sources, and from there, an adjustment to a component can be performed. A component or components creating a light artifact contained in a first image can also be located based on characteristics of a light artifact itself, for example, location in an image, hue, shade, type, other, or a combination thereof. Adjustments to a component or components fall into one or more categories. These categories include: changing a position and/or orientation; adding a material to the camera to, for example, increase an absorption of light; removing a component from a camera; altering one or more dimensions of a component; or any other means of adjusting a component and/or a camera. Adjustments can also be made in combination using more than one of the preceding means listed.

At 750, if, following at least one adjustment to a component, a third image is captured which satisfies one or more thresholds, a camera is deployed. One or more thresholds to be met in order for a camera to be deployed can vary depending on an intended use of a camera. For example, in an embodiment, one or more thresholds are a measure of image clarity under nighttime conditions. In another embodiment, one or more thresholds are a percent reduction in a number of total light artifacts discovered during testing procedures. In some embodiments, more than one threshold needs to be met before a camera undergoing testing is deployed for use in a vehicle. Examples of additional thresholds include contrast and sharpness across a partial or full field-of-view, relative illumination, light artifact intensity, and others.

In some embodiments, more than one modification to a component may be required, while in other embodiments, more than one component is modified before a threshold or thresholds are met. In further embodiments, multiple modifications may accomplish the same result, and other factors are used to determine which modification to make, such as cost, time, or impact on other light artifacts, in addition to other considerations.

The threshold or thresholds to be met in order for a camera to be deployed may require multiple iterations of the process 700 outlined above. Specifically, for example, meeting at least one threshold may require iterating until an entire light array is used to test as many possible positions and/or intensities of light sources as possible. In some embodiments, only portions of a process 700 are iterated, including, as mentioned previously, operations 710 and 720 to locate at least one light artifact.

Once a camera has met the one or more thresholds, future camera undergoing testing of a same or similar type, or which share a similar feature or features, can rely upon information gained during process 700 in order to bypass or modify some or all of the operations contained within process 700.

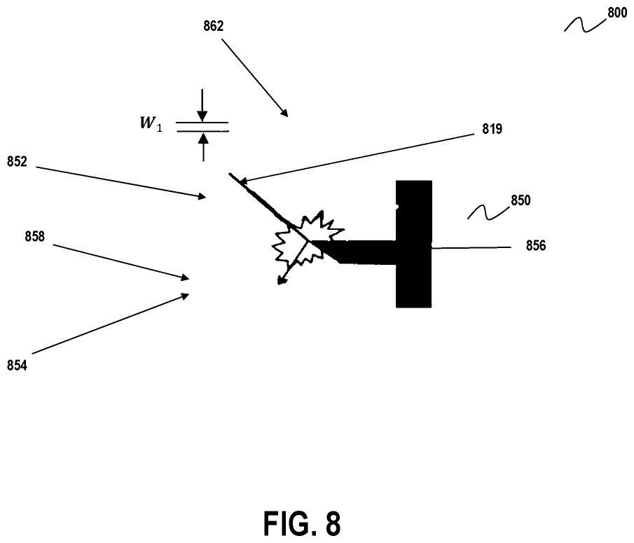

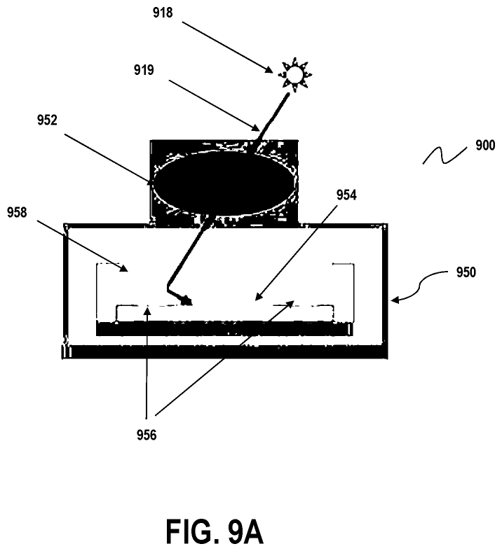

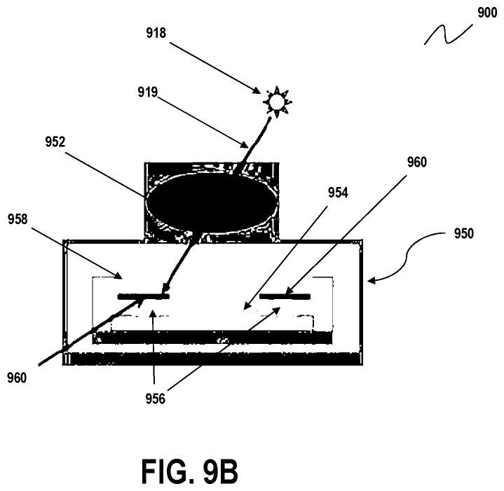

Referring now to FIGS. 8-9B, illustrated are example modifications to a camera system to eliminate or reduce the presence of light artifacts after identifying a contributing component in the camera. FIG. 8 depicts a partial cross-sectional view of a camera system 850, which includes the presence of a shower flare. FIGS. 9A and 9B depict a modification 900 in the form of an addition of a material to a camera system 950 to absorb stray light, where a material is in the form of black masking 960 being introduced to cover epoxy 956.

FIG. 8 depicts a ray of light 819 entering a camera system 800 and contributing to the creation of a light artifact. Shown in the depiction is a partial cross-sectional representation of an internal structure of a camera 850, including a lens 852, a sensor package 854, a baffle 856, a glass covering for the sensor package 858, and a lens aperture 862 having a width Wi. A ray of light 819 is also shown entering a camera system 850 through a lens 852 and then passing through a glass covering 858 and hitting a sensor package 854 after reflecting off of an edge of a baffle 856.

These impacts off of a side edge of a camera component, in this case baffle 856, are one example of a light artifact known as a shower flare. A ray of light 819 passes through a lens 852 and hits a side edge of a baffle 856, which has some inherent width. Due to manufacturing tolerances and constraints, a baffle 856 cannot be made to come to a perfect taper. However, a width of a baffle 856 can be reduced to minimize the impact of shower flares. A lens aperture 862 is shown having its own width, Wi, which can contribute to the creation of shower flares by redirecting light rays and resulting in incidental impacts with a sensor. In some embodiments, Wi is thinned to minimize the dimension as much as possible, for example less than 50 μm, thereby reducing a lens aperture's 862 contribution to the creation of shower flares.

FIG. 9A includes a similar depiction of a ray of light 919 entering a camera system 950 as described above with respect to FIG. 8. FIG. 9A shows a camera system 950 including a lens 952, a sensor package 954, a glass covering for the sensor package 958, and epoxy 956 disposed proximate to a sensor package 954 and attached to a glass covering 958. A ray of light 919 is shown being emitted from a light source 918 and passing through a lens 952. A ray of light 919 passes through a glass covering 958 and bouncing off epoxy 956 before hitting a sensor package 954. Such a redirection and scattering of the ray of light 919 could contribute to the presence of a light artifact in images taken by a camera system 950.

Employing the process 700 of FIG. 7 to a camera system 950 of FIG. 9A can result in the identification of an epoxy 956 as being a contributing component to the creation of a light artifact present in images taken with a camera system 950. FIG. 9B depicts a modification to the camera system 950 in the form of an addition of black masking 960 covering a contributing component—an epoxy 956. The addition of black masking 960 functions to absorb future stray light from light source 918 entering a camera system 950 through a camera lens 952 and striking an epoxy 956. This absorption will reduce or prevent light artifacts resulting from a future light source positioned at a same position as a light source 918.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
receiving a first image of a light array captured by a camera;
analyzing, using at least one data processor, the first image to detect a first light artifact;
receiving a second image of the light array, captured by the camera, in which a first light source in the light array is turned off; and
in response to determining that the first light artifact is absent from the second image, determining, using the at least one data processor and based on a position and/or an intensity of the first light source, a first adjustment for the camera.

2. The method of claim 1, further comprising:
in response to the first light artifact being present in the second image, capturing a third image in which a second light source in the light array is turned off; and
in response to the first light artifact being absent from the third image, determining the first adjustment based on at least one of a position and an intensity of the second light source.

3. The method of claim 1, further comprising:
in response to the first image containing a second light artifact, determining a second adjustment for the camera.

4. The method of claim 3, wherein the second adjustment is determined based on the position and/or intensity of the first light source in response to the second light artifact being absent from the second image.

5. The method of claim 3, wherein the second adjustment is determined based on a position and/or an intensity of a second light source in the light array in response to the second light artifact being absent from a third image captured with the second light source turned off.

6. The method of claim 1, further comprising:
capturing, using the camera having the first adjustment, a third image of the light array; and
in response to the third image satisfying one or more thresholds, deploying the camera for use in a vehicle.

7. The method of claim 1, further comprising:
changing at least one of a pitch, a roll, or a yaw of the light array.

8. The method of claim 1, wherein the light array comprises a plurality of light sources disposed on a spherical surface or a hemispherical surface.

9. The method of claim 8, wherein the plurality of light sources in the light array are substantially equidistant from one or more lenses of the camera.

10. The method of claim 1, wherein the first adjustment includes changing at least one of a position and an orientation of at least one component of the camera.

11. The method of claim 1, wherein the first adjustment includes adding at least one material to the camera to increase absorption of stray light.

12. The method of claim 1, wherein the first adjustment includes removing at least one component of the camera.

13. The method of claim 1, wherein the first adjustment includes altering one or more dimensions of at least one component of the camera.

14. The method of claim 1, wherein the first light source is outside of a field of view of the camera.

15. The method of claim 1, wherein the analyzing includes comparing a plurality of pixel hues present in the first image.

16. The method of claim 1, wherein the first light artifact includes a flare or a ghosting.

17. A system, comprising:
a vehicle including at least one camera having a first adjustment determined by at least
receiving a first image of a light array captured by the at least one camera;
analyzing, using at least one data processor, the first image to detect a first light artifact;
receiving a second image of the light array, captured by the at least one camera, in which a first light source in the light array is turned off; and
in response to determining that the first light artifact is absent from the second image, determining, using the at least one data processor and based on a position and/or an intensity of the first light source, the first adjustment for the camera.

18. The system of claim 17, wherein the first adjustment is further determined by at least
in response to the first light artifact being present in the second image, capturing a third image in which a second light source in the light array is turned off; and
in response to the first light artifact being absent from the third image, determining the first adjustment based on at least one of a position and an intensity of the second light source.

19. The system of claim 18, wherein the at least one camera further includes a second adjustment determined in response to the first image containing a second light artifact.

20. The system of claim 19, wherein the second adjustment is the position and/or intensity of the first light source in response to the second light artifact being absent from the second image, and wherein the second adjustment is determined based on a position and/or an intensity of a second light source in the light array in response to the second light artifact being absent from a third image captured with the second light source turned off.
